(19) United States
(12) Patent Application Publication
(10) Pub. No.: US 2012/0120958 A1
(43) Pub. Date: May 17, 2012

(54) DEEP SLEEP MODE MANAGEMENT FOR A NETWORK SWITCH

(76) Inventors: Priya Mahadevan, Sunnyvale, CA (US); Puneet Sharma, Palo Alto, CA (US); Sujata Banerjee, Palo Alto, CA (US)

(21) Appl. No.: 13/384,977

(22) PCT Filed: Feb. 1, 2010
(86) PCT No.: PCT/US10/22736

§ 371 Date: Jan. 19, 2012

(51) Int. Cl. H04L 12/56

(52) U.S. Cl. 370/392

(57) ABSTRACT

A switch (100) connected to a network is configured to have one or more components that can be placed in a deep sleep mode. The switch (100) includes a management circuit (150) that is configured to wake up the components in deep sleep mode. The management circuit (150) includes a port (151) that receives packets and a wake-up circuit (152) that determines whether a packet received via the port (151) is a magic packet including a unique ID for the port (151) or the switch (100). If the packet is the magic packet including the unique ID for the port (151) or the switch (100), the wake-up circuit (151) is configured to send a wake-up signal to components in the switch (100) to wake up from the deep sleep mode.

### BACKGROUND

In general networking devices including switches are designed to be always-on. For example, in switches, ports consume power even if not being used to communicate data. While unused servers, laptops, desktops, etc., are usually turned off or put into sleep states (i.e., hibernation states) in order to save power, this technique is typically not supported for switches.

Enterprise and data center networks, while designed to be over-provisioned and highly redundant are, on an average, lightly utilized and in fact are idle over long periods of time. Thus, there may be ample opportunity for power savings in these networks by allowing network devices to be put into sleep states. For example, a data center may have several racks where some or all the servers are turned off. However, the switches that connect these inactive servers to the network are active and consume significant energy because the switches need to be active in case the servers become active and need to communicate via the network. Furthermore, if the switches are in a sleep state, there is no network connectivity with the switch to turn it on via the network. Thus, the switch would have to be turned on manually, which is not a feasible solution for large networks.

### BRIEF DESCRIPTION OF DRAWINGS

The embodiments of the invention will be described in detail in the following description with reference to the following figures.

FIG. 1 illustrates a network switch according to an embodiment;

FIG. 2 illustrates a network switch according to another embodiment;

FIG. 3 illustrates a network topology according to an embodiment;

FIG. 4 illustrates a method of managing a switch according to an embodiment; and

FIG. 5 illustrates a method of waking up one or more components of a switch according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

According to an embodiment, one or more components of a switch are placed in a deep sleep mode to minimize power consumption of the switch when it is not being used. A switch is a networking device that connects to one or more network segments. Some examples of switches include large switches, for example for use in data centers, switches for use in a home or small business, hubs, repeaters, etc.

The deep sleep mode is a mode where one or more components of the switch are turned off or are minimally functional but consume minimal power, e.g. less than 25% of the power it would consume in a non-sleep mode or state. The deep sleep mode allows the entire switch to be turned off or one or more of the components to be turned off, with the exception of a management circuit, to maximize power savings. The management circuit includes a port and a wake-up circuit. The management circuit is maintained on (i.e., consumes power and is functional) when the switch is in deep sleep mode and is used to turn the sleeping components of the switch on (i.e., wake up the switch) when needed. For example, a management node or other network device may communicate with the management circuit in the switch via a network to wake up the switch from the deep sleep state.

The switch may enter into a deep sleep mode when it is assumed or estimated that the switch will be idle for long durations, such as a few minutes or more. When no data is determined to be received or transmitted on a port for shorter periods of time, such as few milliseconds or even a few seconds, the switches port could enter into a low-power or idle mode. However, typically, in the low power or idle mode, the switch's processors, backplanes, memory, etc., are still powered on and only the PHY of individual ports enters into a low power mode. In contrast, n the deep sleep mode, a chassis of the switch, which may include the backplane, fans, processor, memory, etc., and other components may be turned off or substantially non-functional so they consume minimal power. If a controller in the chassis and other components in the chassis are in deep sleep mode, the switch likely cannot perform its typical functions of routing packets. However, through the management circuit, the components of the switch can be woken up from deep sleep mode when required, so the switch becomes operational to perform its typical functions.

Note that placing the chassis of the switch in a deep sleep mode is a considerable power savings over merely placing line cards or ports in the switch in a sleep state because the chassis of the switch may be responsible for as much as 70% of the total power consumption of the switch.

The amount of power consumed in the deep sleep mode can be negligible and thus can result in almost 100% power savings. Given that a switch may have maximum power consumption from 150 Watts (W) to more than 2000 W depending on the switch type, if the deep sleep mode and wake up mechanisms of the embodiments are implemented in all switches in data centers and enterprises globally, the energy savings can be considerable.

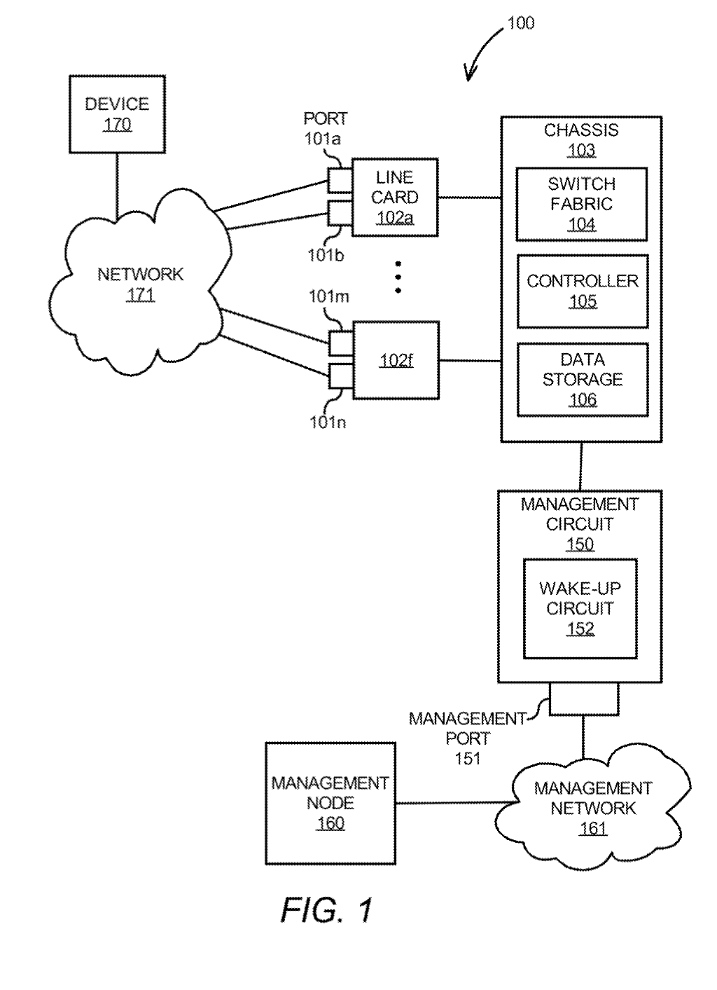

FIG. 1 illustrates a switch 100, according to an embodiment. The switch 100 includes ports 101a-n for sending and receiving data on a network. The ports 101a-n are conventional switch ports and may include basic hardware transmission circuitry, known as the physical layer or PHY, for transmitting and receiving bits over a physical link in a network.

The switch 100 may include other conventional circuits such as line cards 102a-f, and chassis 103. Each of the line cards 102a-f may include multiple ports and port capacities, For instance, an HP ProCurve 5406z1 switch may have up to 6 line-cards, each line-card may have 24 ports, each port supporting 1 Gigabit per second (Gbps) in the full-duplex mode, and/or a line-card may have 4 ports, each port supporting 10 Gbps.

Each of the line cards 102a-f is connected to the chassis 103. The line cards 102a-f may be pluggable line cards that can be plugged into the chassis 103. The chassis 103 may include a plurality of slots (not shown), wherein line-cards 102a-f may be inserted as required. For instance, the switch 100 may have from 1 to 12 slots for inserting line cards as is known for switches deployed in data centers or as network edges. In other instances, the line cards 102a-f are non-pluggable and integrated in the switch 100.

The chassis 103 may include a high-speed switch fabric 104, controller 105, and data storage 106. The controller 105 may include a management CPU running software for managing various switch functions. The controller 105 is described as being in the chassis 103, but in another embodiment it may be located on a line card. The controller 105 in the chassis 103 may communicate with the line cards 102a-f to route received data packets to particular ports so packets are transmitted from the ports on network segments towards their destinations. The data storage 106 stores configuration information for the switch 100. Examples of the data storage 106 include RAMs, TCAMS, etc. The configuration information may include state information used by the controller 105 when waking up the ports and other circuits in the switch. The state information may include speed of ports if it may be varied, routing tables, IP address or MAC address for each port, etc. The state information may be saved in the data storage 106 prior to entering deep sleep mode and is re-instated when waking up.

Line cards and other components may or may not be included in the switch 100. Also, other conventional components not shown may be included in the switch 100.

According to an embodiment, the switch 100 also includes a deep sleep power management circuit 150, referred to herein as management circuit 150. The management circuit 150 includes a management port 151 and a wake-up circuit 152. The management port 151 includes a PHY layer configured to receive packets, similar to the ports 101a-n. The wake-up circuit 152 is configured to detect a magic packet and send wake-up signals to one or more components in the switch 100 to wake-up the components of the switch 100 so the switch is operable to send or receive data over network segments. The management circuit 150 may be designed to consume a minimal amount of power. For example, the wake-up circuit 152 may be an ASIC or some other limited-functionality circuit that detects magic packets and sends signals to wake-up the controller 105 and/or other components. Although not shown, the management port 151 may be provided on a line card or may be directly connected to the chassis.

The magic packet may be a packet with a unique bit pattern that is easily identifiable by the wake-up circuit 152. The predetermined bit pattern may be provided in the header or payload of a packet. The magic packet may also include a unique ID for the management port 151 or the switch 100. The unique ID may be a MAC or IP address. The magic packet may be similar to or in the same format as a packet used by conventional remote wake-up technology for waking up client devices or servers. The magic packet may be sent by a management node 160 connected to the switch 100 via a management network 161 to wake-up the switch 100. The magic packet is received on the management port 151. The wake-up circuit 152 detects the magic packet and sends a signal to wake-up components of the switch 100. In one embodiment, the management node 160 is connected to the management port 151 via the management network 161, and the ports 101a-n are connected to other devices 170, such as other switches, servers, client devices, etc., via a different network 171 that carries data traffic that may be routed by the switches. The management network 161 may be primarily used by management nodes to send and receive data for managing devices in the network. The network 171 is referred to as a data network and is primarily used for routing data other than network management data between nodes in the network. In another embodiment, the management node 160 is connected to the management port 151 via the same network that is used to connect the devices 170 to the switch 100.

The management node 160 may decide when to place a switch in deep sleep mode. For example, this action can be taken when, say, all the servers to a switch have been put to sleep. The management node 160 sends a signal to the management circuit 150 to place the switch in deep sleep mode, The management circuit 150 may then send a signal to the controller 105 to place the switch 100 in deep sleep mode. The controller 105 then controls the components to power down, except for the management circuit 150 and any other circuit needed to wake up components of the switch 100 in response to receiving a signal from the wake-up circuit 152 to come out of the deep sleep mode. For example, in the deep sleep mode, the controller 105 may need to be able to detect a “high” voltage on an input that indicates to wake-up from sleep mode.

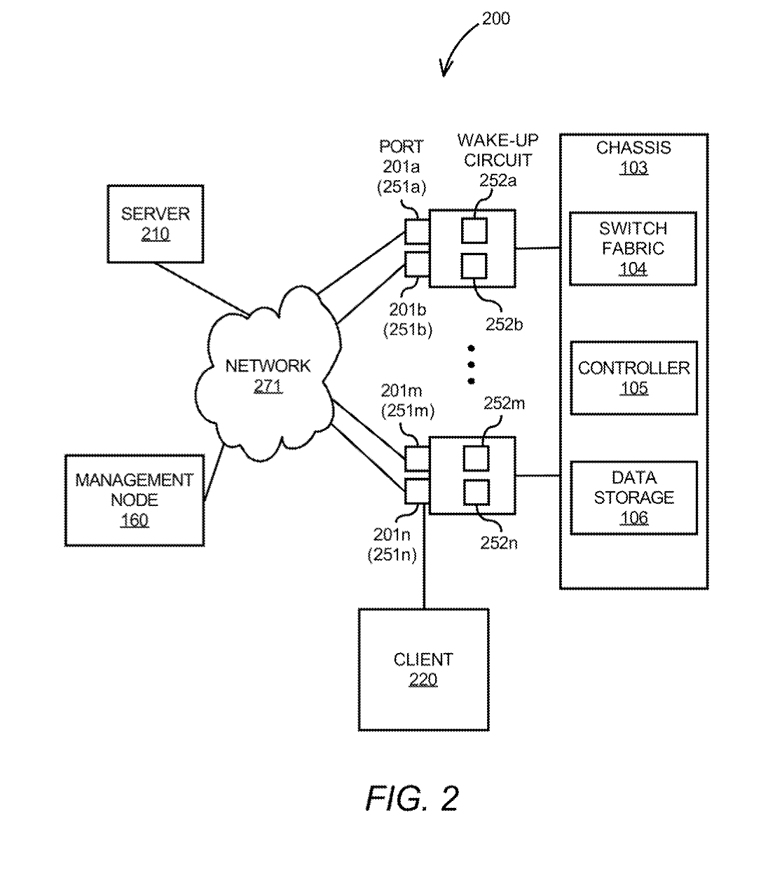

FIG. 2 illustrates another embodiment, whereby the management circuit may be integrated with a conventional port on a switch. FIG. 2 shows a switch 200. Most of the components are the same as the switch 100, except the ports 201a-n are also management ports 251a-n. The management ports 251a-n are connected to wake-up circuits 252a-n, respectively. The wake-up circuits 252a-n operate the same as the wake-up circuit 152 shown in FIG. 1, including waking up components of the switch 200 from deep sleep mode in response to receiving a magic packet with a corresponding MAC or IP address. The ports 201a-n also operate as conventional switch ports, similar to ports 101a-n of FIG. 1, for sending and receiving data on network segments when the switch is awake. A wake-up circuit is shown for each port as an example. In another embodiment a wake-up circuit services multiple ports.

In the embodiment of FIG. 2, clients and servers, as well as a management node, can wake up the switch 200 from deep sleep mode by sending a magic packet to any of the ports 201a-n in the switch 200 over network 271. For example, server 210 is placed in a sleep state and is timed to wake up after a certain time interval. The server 210 is connected to the switch 200 via port 201a, which is also management port 251a. The server 200 stores the MAC address of the port 201a. Upon waking up, the server 210 sends a magic packet to the switch 200 including the MAC address of the port 201a. The wake-up circuit 252a determines the packet is a magic packet (e.g., includes a predetermined bit pattern) and includes the MAC address for the port 201a. Then, the wake-up circuit 252a sends one or more signals to wake-up the controller 105 and any other circuits needed to process and route packets from the server 200.

In this embodiment, all the ports 201a-n are shown as management ports by way of example. In other embodiments, only one of the ports 201a-n or some of the ports 201a-n are management ports.

The management node 160 may also wake-up the switch 200 by sending a magic packet to one of the ports 201a-n. In one example, the management node 160 may use a schedule to wake-up multiple switches. For example, all conference room switches are put into deep sleep mode at 8 PM every weeknight by the management node 160 sending the switches a signal to be placed into deep sleep mode. Then, the management node 160 sends a magic packet to each of the switches to wake them up every weekday at 6 AM.

A client may also be able to wake up a switch. For example, client 220 is directly connected to port 201n in the switch 200 via a cable being plugged into one of its ports or through a wireless connection. The wake-up circuit 152n automatically detects the cable connection or wireless connection to the port and wakes up the switch 200. In another embodiment, the client 220 may send a magic packet to wake up the switch 200. In another embodiment, sensors notify the management node 160 that a user has entered the conference room, and the management node 160 sends a magic packet to the switch to wake it up.

The management node 160 may store the MAC or IP addresses for all the management ports in all the switches that the management node 160 manages. In an environment where there are many switches, the management node 160 may also store the topology of the switches in a network. This topology along with the MAC or IP addresses of the switches may be used to identify switches in particular paths that need to be woken up, and the management node 160 can then wake-up the switches by sending them magic packets.

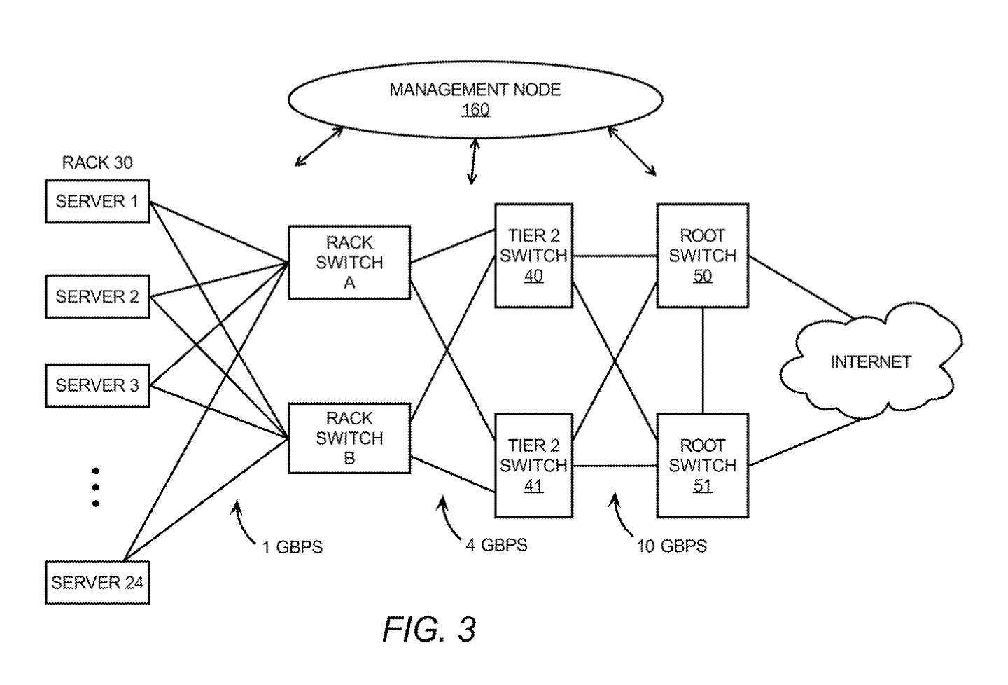

FIG. 3 shows a topology of a data center network, where servers 1-24 in a rack 30 connect to two rack switches A and B. The rack switches A and B connect to tier-2 (or aggregator) switches 40 and 41, which further connect to root (or top) switches 50 and 51 that act as an entry point into the data center. Network devices, such as servers, switches, or any device that can connect to the network, are accessible to one or multiple management node(s) that is(are) responsible for managing the devices. Deep sleep mode and wake-up capability may be supported by the switches A, B, 40, 41, 50, and 51. For example, wake-up circuits may be provided on one or more ports of each switch or via a management port to allow the switches to be managed by a management node or other device.

In FIG. 3, if the management node 160 decides that rack switch A needs to be woken up in order to get it to forward packets, then the management node 160 sends a magic packet to one of the switch's ports via a network. Although not specifically shown, the management node 160 is connected to each of the devices shown in FIG. 3 via the network either directly or indirectly through other switches. The magic packet is either sent directly to the port on which the management node 160 is connected to the rack switch A or the magic packet is forwarded by another switch, such as one of the tier-2 switches. To achieve this task, the management node 160 stores the topological information of the network and the status of the clients and switches (whether sleeping or awake). If rack switch A needs to be woken up from deep sleep mode, the magic packet may need to be forwarded along switches that are already awake. Hence the management node 160 determines the forwarding path along which the magic packet will be sent to rack switch A. If any intermediate switch along the forwarding path to rack switch A needs to be woken up, then the management node 160 sends a magic packet to the intermediate switch to power it up first, before sending a magic packet to rack switch A. Similarly, before powering up the servers 1-24 in the rack 30, the management node 160 first determines if the switches connected to the corresponding servers are awake. In case the switches are in the deep sleep mode, the management node 160 wakes up the switches. For example, after a magic packet is sent to wake the rack switch A, the management node 160 waits for the rack switch A to be fully powered on and ready to forward packets before waking the associated server. Also, note that the servers 1-24 if already awake may send magic packets to rack switches A and B to wake them up.

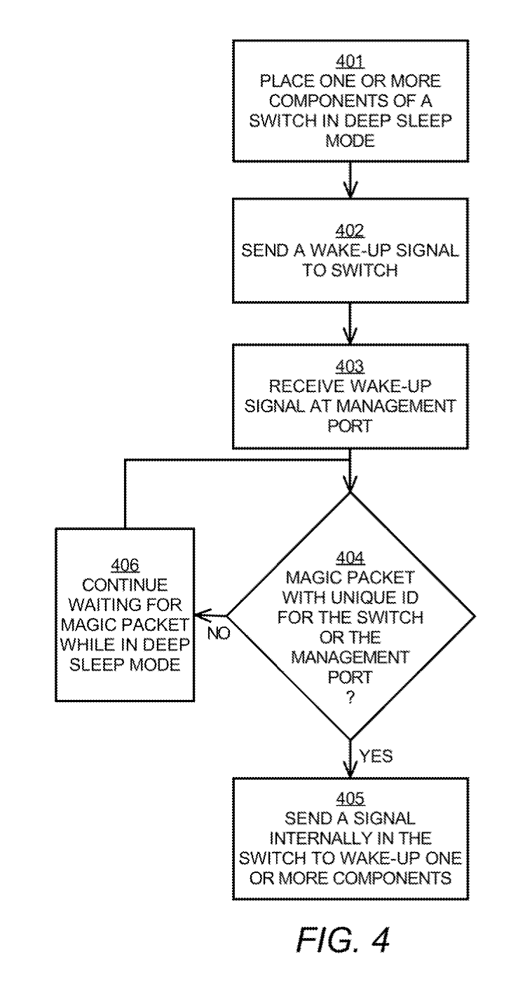

FIG. 4 illustrates a method 400 for managing a switch, according to an embodiment. The method 400 and a method 500 described below may be performed by the switches 100 or 200 described above but it will be apparent to one of ordinary skill in the art that the method may be performed by other switches.

At step 401, one or more components of a switch are placed in a deep sleep mode. For example, the management node 160 shown in FIGS. 1-3 or another network device sends a signal to the switch to place one or more components in deep sleep mode. In response to receiving the signal indicating to place one or more components in deep sleep mode, the controller in the switch then sends a sleep signal to one or more components in the switch to place in deep sleep mode and may place itself in deep sleep mode. The switch may be inoperative in deep sleep mode, for example, if the controller, ports and line cards are turned off.

At step 402, the management node or another network device sends a wake-up signal to wake-up the switch. The wake-up signal may be broadcast or unicast. The wake-up signal may include a magic packet with a predetermined bit pattern and a unique ID for the switch or management port in the switch. The port may be a management-only port, such as management port 151 shown in FIG. 1 or management port 251a shown in FIG. 2 that also operates as a conventional switch port.

At step 403, the management port of the switch in deep sleep mode receives the wake-up signal.

At step 404, a wake-up circuit connected to the management port, such as wake-up circuits 152 and 252a shown in FIGS. 1 and 2 respectively, determines whether the received wake-up signal includes a magic packet with a predetermined bit pattern and a unique ID for the switch or the management port. For example, the wake-up circuit determines whether a packet in the received signal includes the predetermined bit pattern for the magic packet and whether the packet includes the unique ID.

At step 405, if the wake-up circuit determines the signal includes the magic packet with the unique ID, the wake-up circuit sends a signal internally in the switch to wake-up one or more components in the switch.

As described above, at step 404, a wake-up circuit determines whether the received wake-up signal includes a magic packet with a predetermined bit pattern and a unique ID for the switch or the management port. As shown with respect to step 406, the wake-up circuit continues to perform this step while in deep sleep mode. Furthermore, step 404 is not just performed when a wake-up signal is received such as described at step 403. If the switch is in deep sleep mode, step 404 may be performed for any signal received on the management port.

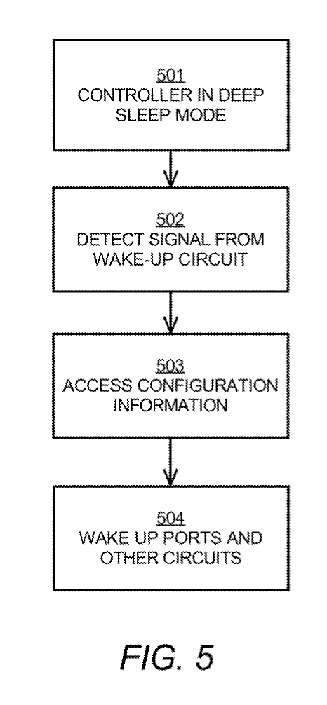

FIG. 5 illustrates a method 500 for waking up the switch, according to an embodiment. The steps of the method 500 may be sub-steps performed for the step 405 in the method 400. At step 501, the controller 105 shown in FIGS. 1 and 2 in the chassis of the switch is in deep sleep mode but is able to detect the signal from the wake-up circuit.

At step 502, the controller 105 detects the signal from the wake-up circuit, which indicates the controller 105 to wake up.

At step 503, the controller 105 accesses configuration information, for example, stored in the data storage 106. The configuration information may include state information used by the controller 105 when waking up the ports and other circuits in the switch. The state information may include speed of ports if it may be varied, routing tables, IP address or MAC address for each port, etc. The state information may be saved in the data storage 106 prior to entering deep sleep mode and is re-instated when waking up. The configuration information may also identify the ports and associated circuits to wake up if a subset of the ports rather than all the ports are to be woken up. For example, the ports, line cards for the ports and other circuitry between the ports and the controller 105 may need to receive a signal to wake up. The controller 105 may send the signal to wake up those circuits if needed.

At step 504, the controller 105 wakes up the ports and other circuits, As indicated above, this may include sending a signal to wake up the ports and associated circuits. The controller 105 may also configure the circuits as indicated in the configuration information, such as setting the speed of the ports, selecting which ports and circuits to wake up, etc.

One or more of the above-described steps, functions or operations may be embodied in computer instructions in a computer program and stored in data storage and executed by computer hardware, which may be a processor, ASIC, or other circuit. Exemplary tangible computer readable storage mediums include conventional computer system RAM, ROM, EPROM, EEPROM, and magnetic or optical disks or tapes.

While exemplary features and embodiments of FIGS. 1-4 have been explained within the context of each feature and embodiment, any one or all of the exemplary features and embodiments of the invention may be applied and is incorporated in any and all of the embodiments of the invention unless clearly contradictory.

While the embodiments have been described with reference to examples, those skilled in the art will be able to make various modifications to the described embodiments without departing from the scope of the claimed embodiments.

What is claimed is:

1. A deep sleep power management circuit (150) in a switch (100) connected to a network, the management circuit comprising:
a port (151) configured to receive a packet via the network;
a wake-up circuit (152) configured to determine whether the packet is a magic packet including a unique ID for the port (151) or the switch (100), wherein
if the packet is the magic packet including the unique ID for the port (151) or the switch, the wake-up circuit (152) is configured to send a wake-up signal to at least one component in the switch (100) to wake up the at least one component from a deep sleep mode.

2. The management circuit of claim 1, wherein the network is a management network (161) used to send and receive data for managing network devices in a separate data network (171) carrying traffic.

3. The management circuit of claim 2, wherein the port (151) is a management-only port connected to the management network (161), and the port (151) is configured to receive the magic packet from a management node via the management network (161).

4. The management circuit of claim 1, wherein the port (151) is connected to a network device including at least one of a client, server, another switch in the network, and a management node.

5. The management circuit of claim 4, wherein the port (151) is configured to receive the magic packet from another network device and is also configured to receive other traffic for the network device.

6. The management circuit of claim 1, wherein the port (151) is configured to directly connect to a device via a connection outside the network and the wake-up circuit (152) is configured to send the wake-up signal to the at least one component in response to detecting the device being connected to the port (151) via the connection.

7. The management circuit of claim 1, wherein the at least one component comprises a controller (105) in a chassis (103) of the switch (100).

8. The management circuit of claim 1, wherein the at least one component comprises a controller (105) in a chassis (103) of the switch (100), other ports in the switch (100), and circuits between the other ports and the controller (105), wherein the controller (105), other ports and circuits are inoperable in the deep sleep mode except to be woken up.

9. A switch (100) connected to a network and configured to operate in a deep sleep mode and minimizes power consumption in the deep sleep mode, the network switch (100) comprising:
a chassis (103) including a controller (10);
a port (151) configured to receive a packet via the network; and
a wake-up circuit (152) configured to determine whether the packet is a magic packet including a unique ID for the port (151) or the switch (100), wherein
if the packet is the magic packet including the unique ID for the port (151) or the switch (100), the wake-up circuit (152)is configured to send a wake-up signal to at least one component in the switch to wake up the at least one component from a deep sleep mode.

10. The switch of claim 9, wherein the network is a management network (161) used to send and receive data for managing network devices in a separate data network (171) carrying traffic for the network devices.

11. The switch of claim 11, wherein the port (151) is a management port connected to the management network (161), and the port (151) is configured to receive the magic packet from a management node via the management network (161).

12. The switch of claim 9, wherein the port (151) is connected to a device including at least one of a client, server, another switch in the network, and a management node.

13. The switch of claim 12, wherein the port (151) is configured to receive the magic packet from the network device and is configured to receive traffic to be routed to another network device.

14. The switch of claim 9, wherein the port (151) is configured to directly connect to a device via a connection outside the network and the wake-up circuit (152) is configured to send the wake-up signal to the at least one component in response to detecting the device being connected to the port (151) via the connection.

15. A method of managing a switch (100) connected to a network, the method comprising:
placing (401) at least one component of the switch (100) in a deep sleep mode;
maintaining a management circuit (150) as on while the at least one component is in deep sleep mode, wherein the management circuit (150) includes a port (151) and a wake-up circuit (152);
receiving a packet at the port (151);
determining, by the wake-up circuit (152), whether the packet is a magic packet including a unique ID for the port (151) or the switch (100); and
if the packet is the magic packet including the unique ID for the port (151) or the switch (100), sending a wake-up signal to the at least one component in the switch (100) to wake up the at least one component from a deep sleep mode.
